(19) United States
(12) Patent Application Publication
(10) Pub. No.: US 2025/0278651 A1
(43) Pub. Date: Sep. 4, 2025

(54) SUPPORT METHOD, RECORDING MEDIUM, AND SUPPORT SYSTEM

(71) Applicant: SCREEN Holdings Co., Ltd., Kyoto (JP)

(72) Inventors: Takashi IKEUCHI, Kyoto-shi (JP); Takehiro SANO, Kyoto-shi (JP); Kazuma NAKAGAWA, Kyoto-shi (JP)

(73) Assignee: SCREEN Holdings Co., Ltd., Kyoto (JP)

(21) Appl. No.: 19/001,580

(22) Filed: Dec. 26, 2024

(30) Foreign Application Priority Data
Feb. 29, 2024 (JP) 2024-029928

(51) Int. Cl. G06N 7/01

(52) U.S. Cl. CPC G06N 7/01

(57) ABSTRACT

A support method supports exploration of a value of an explanatory variable that maximizes or minimizes an expected value of a response variable, and includes: outputting, from a first machine learning model, a first predictive distribution which is a predictive distribution of the expected value of the response variable; outputting, from a second machine learning model, a second predictive distribution which is a predictive distribution of a variance of the response variable; constructing a third predictive distribution that integrates the first predictive distribution and the second predictive distribution; and a recommended value acquisition process of executing parallel Bayesian optimization based on the third predictive distribution, at least one acquisition function, and an exploration range, and acquiring at least one recommended value of the explanatory variable that maximizes the acquisition function from within the exploration range.

### CROSS-REFERENCE TO RELATED APPLICATION

This application claims the priority benefit of Japan application serial no. 2024-029928, filed on Feb. 29, 2024. The entirety of the above-mentioned patent application is hereby incorporated by reference herein and made a part of this specification.

### BACKGROUND

### Technical Field

The disclosure relates to a support method, a recording medium, a support program, and a support system.

### Related Art

Techniques have been known to perform Bayesian optimization on a dataset in which an explanatory variable and a response variable are associated with each other, and estimate a value of the explanatory variable that optimizes (minimizes or maximizes) a value of the response variable (e.g., refer to JP 2023-174450 A). Specifically, a machine learning model is caused to learn (machine learn) the dataset, and a predictive distribution (posterior distribution) of the response variable is outputted from the machine learning model. Then, based on the predictive distribution of the response variable, an acquisition function, and an exploration range, a value (recommended value) of the explanatory variable that maximizes the acquisition function is explored from within the exploration range as a candidate for an optimal solution.

One type of Bayesian optimization is parallel Bayesian optimization. In parallel Bayesian optimization, the acquisition function used in general Bayesian optimization is employed. According to parallel Bayesian optimization, multiple recommended values can be explored in a single process, which allows the operator to more efficiently determine the value of the explanatory variable that optimizes (minimizes or maximizes) the value of the response variable.

In addition, a value (observed value) of the response variable obtained by an experiment may exhibit different values for each experiment even if the experiment is performed using the same explanatory variable (same experimental condition). In other words, the observed value includes observation noise. Furthermore, a variance of the observation noise added to the value of the response variable may differ for each value of the explanatory variable. Such observation noise is referred to as heteroscedastic observation noise.

Heteroscedasticity Bayesian optimization has been proposed as a technology for performing Bayesian optimization that takes into account heteroscedastic observation noise. In heteroscedasticity Bayesian optimization, the predictive distribution of the expected value of the response variable and the predictive distribution of the heteroscedastic observation noise variance are used. Additionally, in heteroscedasticity Bayesian optimization, an acquisition function different from general Bayesian optimization is employed. Specifically, the acquisition function expressed by the following Formula (1) and the acquisition function expressed by the following Formula (2) have been proposed as the acquisition function used in heteroscedasticity Bayesian optimization.

$${UCB}_{f} ( x ) - α {LCB}_{g} ( x ) \qquad ( 1 )$$

$${EI}_{f} ( x ) - α \sqrt{IE [ g \vert D ]} \qquad ( 2 )$$

Formula (1) is defined based on a UCB (Upper Confidence Bound) acquisition function and an LCB (Lower Confidence Bound) acquisition function. In Formula (1), UCB of the first term indicates the acquisition function with respect to the predictive distribution of the expected value of the response variable. LCB of the second term indicates the acquisition function with respect to the predictive distribution of the heteroscedastic observation noise variance.

Formula (2) is defined based on an EI (Expected Improvement) acquisition function. In Formula (2), EI of the first term indicates the acquisition function with respect to the predictive distribution of the expected value of the response variable. The following Formula (3) included in the second term indicates the expected value of the predictive distribution of the heteroscedastic observation noise variance.

$$IE [ g \vert D ] \qquad ( 3 )$$

The coefficient α included in Formula (1) and Formula (2) is a risk aversion coefficient. In heteroscedasticity Bayesian optimization, the larger the value of the risk aversion coefficient α becomes, the more actively the region predicted to have large observation noise is avoided to explore the candidate for the optimal solution.

However, the acquisition function used in heteroscedasticity Bayesian optimization cannot be used for parallel Bayesian optimization. Therefore, it is not possible to perform parallel Bayesian optimization that takes into account heteroscedastic observation noise.

At least one aspect of the disclosure provides a support method, a recording medium, a support program, and a support system capable of performing parallel Bayesian optimization that takes into account heteroscedastic observation noise.

### SUMMARY

According to an aspect of the disclosure, a support method is provided for supporting exploration of a value of an explanatory variable that maximizes or minimizes an expected value of a response variable. The support method includes: outputting, from a first machine learning model capable of outputting a predictive distribution, a first predictive distribution which is a predictive distribution of the expected value of the response variable; outputting, from a second machine learning model capable of outputting a predictive distribution, a second predictive distribution which is a predictive distribution of a variance of the response variable; constructing a third predictive distribution that integrates the first predictive distribution and the second predictive distribution; and a recommended value acquisition process of executing parallel Bayesian optimization based on the third predictive distribution, at least one acquisition function, and an exploration range, and acquiring at least one recommended value of the explanatory variable that maximizes the acquisition function from within the exploration range.

In an embodiment, in the recommended value acquisition process, multiple recommended values are acquired.

In an embodiment, the first machine learning model and the second machine learning model each include a twice-differentiable kernel function. The at least one acquisition function includes a Monte Carlo acquisition function.

In an embodiment, the at least one acquisition function includes Thompson sampling and multiple Monte Carlo acquisition functions with different properties from each other. In the recommended value acquisition process, multiple recommended values are acquired from the Thompson sampling, and multiple recommended values are acquired from each of the multiple Monte Carlo acquisition functions.

According to an aspect of the disclosure, a recording medium is a computer-readable medium. The recording medium records a support program specifying the above support method.

According to an aspect of the disclosure, a support program is a computer program executable by a computer. The support program specifies the above support method.

According to an aspect of the disclosure, a support system is a system supporting exploration of a value of an explanatory variable that maximizes or minimizes an expected value of a response variable. The support system includes a storage part and a processing part. The storage part stores a first machine learning model capable of outputting a predictive distribution, a second machine learning model capable of outputting a predictive distribution, and at least one acquisition function. The processing part outputs a first predictive distribution, which is a predictive distribution of the expected value of the response variable, from the first machine learning model, and outputs a second predictive distribution, which is a predictive distribution of a variance of the response variable, from the second machine learning model. The processing part constructs a third predictive distribution that integrates the first predictive distribution and the second predictive distribution. The processing part executes parallel Bayesian optimization based on the third predictive distribution, the acquisition function, and an exploration range, and acquires at least one recommended value of the explanatory variable that maximizes the acquisition function from within the exploration range.

In an embodiment, the processing part acquires multiple recommended values.

In an embodiment, the first machine learning model and the second machine learning model each include a twice-differentiable kernel function. The at least one acquisition function includes a Monte Carlo acquisition function.

In an embodiment, the at least one acquisition function includes Thompson sampling and multiple Monte Carlo acquisition functions with different properties from each other. The processing part acquires multiple recommended values from the Thompson sampling, and acquires multiple recommended values from each of the multiple Monte Carlo acquisition functions.

The support method, the recording medium, the support program, and the support system according to the embodiments of the disclosure can perform parallel Bayesian optimization that takes into account heteroscedastic observation noise.

### BRIEF DESCRIPTION OF DRAWINGS

FIG. 1 is a block diagram showing a configuration of a support system according to Embodiment 1 of the disclosure.

FIG. 2 is a view showing an example of heteroscedastic observation noise.

FIG. 3 is a flowchart showing a support method according to Embodiment 1 of the disclosure.

FIG. 4A is a view showing an example of an observed value of a response variable.

FIG. 4B is a view showing an example of a first predictive distribution, a second predictive distribution, and a third predictive distribution.

FIG. 4C is a view showing the first predictive distribution of FIG. 4B.

FIG. 4D is a view showing the second predictive distribution of FIG. 4B.

FIG. 4E is a view showing the third predictive distribution of FIG. 4B.

FIG. 5 is a view showing an example of the flow of a recommended value acquisition process.

FIG. 6 is a view showing a procedure of an experiment using the support method, a recording medium, a support program, and the support system according to Embodiment 1 of the disclosure.

FIG. 7 is a block diagram showing a configuration of a support system according to Embodiment 2 of the disclosure.

FIG. 8 is a schematic diagram of a substrate processing system including a support system according to Embodiment 3 of the disclosure.

FIG. 9 is a block diagram showing a configuration of the support system according to Embodiment 3 of the disclosure.

### DESCRIPTION OF EMBODIMENTS

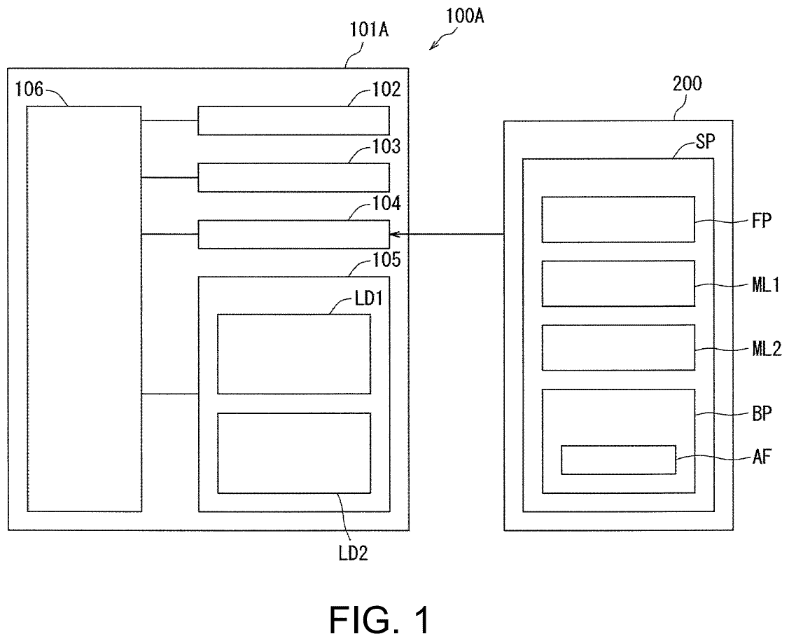

Hereinafter, embodiments related to a support method, a recording medium, a support program, and a support system of the disclosure will be described with reference to the drawings (FIG. 1 to FIG. 9). However, the disclosure is not limited to the following embodiments and may be implemented in various aspects within a range without deviating from the gist thereof. Descriptions may be omitted as appropriate wherever descriptions repeat. Further, in the figures, same or equivalent portions will be labeled with the same reference signs, and descriptions thereof will not be repeated.

### Embodiment 1

First, with reference to FIG. 1, a recording medium 200, a support program SP, and a support system 100A of this embodiment will be described. FIG. 1 is a block diagram showing a configuration of the support system 100A of this embodiment. The support system 100A is a system that supports exploration of a value x (recommended value or candidate value) of an explanatory variable that optimizes (maximizes or minimizes) an expected value (predicted value) of a response variable. As shown in FIG. 1, the support system 100A of this embodiment includes a terminal device 101A. The support program SP is installed on the terminal device 101A from the recording medium 200. The terminal device 101A executes the support program SP installed from the recording medium 200 to explore the value x of the explanatory variable that optimizes the expected value of the response variable. The terminal device 101A is an example of a “support device”. The terminal device 101A may be, for example, a general-purpose computer or a dedicated computer.

Specifically, the recording medium 200 is a computer-readable medium. Programs (computer programs) to be executed by a computer are non-transitorily recorded on the recording medium 200. The support program SP is recorded on the recording medium 200. In other words, the recording medium 200 stores the support program SP. The support program SP is a computer program executable by a computer.

The recording medium 200 may be, for example, a medium including a semiconductor memory such as a secure digital (SD) memory card and a universal serial bus (USB) memory, or may be a medium including a magnetic disk such as a hard disk drive. Alternatively, the recording medium 200 may be an optical disk such as a compact disk (CD), a digital versatile disk (DVD), or a Blu-ray disk, or may be a main storage device or an auxiliary storage device mounted in another computer system.

The support program SP includes a first machine learning model ML1, a second machine learning model ML2, and a heteroscedasticity parallel Bayesian optimization program BP. The heteroscedasticity parallel Bayesian optimization program BP includes at least one type of acquisition function AF. In this embodiment, the support program SP further includes a preprocessing program FP.

The first machine learning model ML1 includes a model capable of outputting a predictive distribution. The first machine learning model ML1 learns (machine learns) a dataset (learning data) in which a response variable and an explanatory variable are associated with each other, and outputs a predictive distribution of an expected value of the response variable. Hereinafter, the predictive distribution outputted from the first machine learning model ML1 may be referred to as “first predictive distribution f|D”. The first predictive distribution f|D is a conditional probability distribution.

The second machine learning model ML2 includes a model capable of outputting a predictive distribution. The second machine learning model ML2 learns (machine learns) a dataset (learning data) in which a variance of the response variable (a variance of an observed value) and the explanatory variable are associated with each other, and outputs a predictive distribution of the variance of the response variable. Hereinafter, the predictive distribution outputted from the second machine learning model ML2 may be referred to as “second predictive distribution g|D”. The second predictive distribution g|D is a conditional probability distribution.

An algorithm of the first machine learning model ML1 is not particularly limited as long as it includes an algorithm capable of outputting a predictive distribution. The first machine learning model ML1 may include, for example, a Gaussian process regression model. Similarly, an algorithm of the second machine learning model ML2 is not particularly limited as long as it includes a model capable of outputting a predictive distribution. The second machine learning model ML2 may include, for example, a Gaussian process regression model.

The preprocessing program FP includes a computer program that executes preprocessing on the dataset (learning data). In this embodiment, the dataset (learning data) after being preprocessed by the preprocessing program FP is inputted to the first machine learning model ML1. Similarly, the dataset (learning data) after being preprocessed by the preprocessing program FP is inputted to the second machine learning model ML2.

The heteroscedasticity parallel Bayesian optimization program BP includes a computer program that constructs a third predictive distribution MV|D in which the predictive distribution (first predictive distribution f|D) outputted from the first machine learning model ML1 and the predictive distribution (second predictive distribution g|D) outputted from the second machine learning model ML2 are integrated. In addition, the heteroscedasticity parallel Bayesian optimization program BP further includes a computer program that executes parallel Bayesian optimization based on the third predictive distribution MV|D, at least one acquisition function AF, and an exploration range, and outputs at least one value x (recommended value or candidate value) of the explanatory variable that maximizes the acquisition function AF. The third predictive distribution MV|D is a conditional probability distribution.

The terminal device 101A includes an operation part 102, a display part 103, an interface part 104, a storage part 105, and a processing part 106.

The operation part 102 includes a user interface device operated by an operator. The operation part 102 inputs a signal corresponding to an operation of the operator to the processing part 106. The operation part 102 may include, for example, at least one of a keyboard, a mouse, and a touch sensor. The touch sensor may be superimposed on a display surface of the display part 103. By superimposing the touch sensor on the display surface of the display part 103, a graphical user interface may be configured. For example, the operator may operate the operation part 102 to instruct installation of the support program SP. Further, the operator may operate the operation part 102 to instruct execution of the support program SP.

The display part 103 is controlled by the processing part 106 to display various screens. For example, the display part 103 may display a source code of the support program SP. For example, when the source code of the support program SP is displayed on the display part 103, the operator may operate the operation part 102 to set the dataset to be learned by the first machine learning model ML1. The display part 103 includes, for example, a display device such as a liquid crystal display device or an organic electroluminescence (EL) display device.

The interface part 104 exchanges information, data, or signals with the recording medium 200. Specifically, the interface part 104 reads the support program SP from the recording medium 200. The support program SP read from the recording medium 200 is stored in the storage part 105 by the processing part 106. As a result, the support program SP is installed on the terminal device 101A.

For example, the interface part 104 may be electrically connected to the recording medium 200 to perform input and output of information, data, or signals from and to the recording medium 200. Specifically, the interface part 104 may include a slot or a USB terminal. For example, a card-shaped information carrier, such as an SD memory card, may be inserted into the slot. For example, a USB memory may be inserted into the USB terminal, or a USB cable with one end electrically connected to a hard disk drive may have the other end inserted into the USB terminal. Alternatively, the interface part 104 may include an optical disk drive. The optical disk drive reads information (data) from a CD, a DVD, or a Blu-ray disk.

The storage part 105 has a main storage device. The main storage device includes, for example, a semiconductor memory. The storage part 105 may further have an auxiliary storage device. The auxiliary storage device includes, for example, at least one of a semiconductor memory and a hard disk drive. The storage part 105 stores various computer programs and various data. Specifically, the storage part 105 stores first learning data LD1 and second learning data LD2. Further, the storage part 105 stores the support program SP installed from the recording medium 200. The support program SP is non-transitorily recorded in the storage part 105. The storage part 105 is a recording medium that non-transitorily records the support program SP.

The first learning data LD1 is a dataset to be learned by the first machine learning model ML1. Specifically, the first learning data LD1 includes a dataset in which the response variable (observed value) and the explanatory variable (experimental condition) are associated with each other.

For example, in the case of seeking an optimal solution for at least one parameter among various parameters that specify an action of a substrate processing apparatus using the support program SP, the response variable may be a number of particles or an evaluation metric value of an etching profile. In that case, the operator repeats an experiment of processing multiple substrates with the substrate processing apparatus multiple times while changing a value (experimental condition) of a parameter which is the explanatory variable, and acquires, for each substrate, a number of particles or an evaluation metric value of the etching profile, which is the response variable. Then, a dataset (first learning data LD1) is created, in which the number of particles or the evaluation metric value of the etching profile of each substrate is associated with the corresponding value (corresponding experimental condition) of the parameter.

The second learning data LD2 is a dataset to be learned by the second machine learning model ML2. Specifically, the second learning data LD2 includes a dataset in which a variance (observed value) of the response variable and the explanatory variable (experimental condition) are associated with each other. In particular, with respect to each value x of the explanatory variable, one or more corresponding values (observed values) of the response variable are associated.

For example, in the case where the response variable is the number of particles or the evaluation metric value of the etching profile, even if multiple substrates are processed by the substrate processing apparatus using a specific value of the parameter, the number of particles or the evaluation metric value of the etching profile differs for each substrate. In other words, the number of particles or the evaluation metric value of the etching profile exhibits dispersion. Further, a degree of variation in the number of particles or the evaluation metric value of the etching profile differs for each value of the parameter. That is, the number of particles or the evaluation metric value of the etching profile exhibits heteroscedasticity. In other words, the observed value (the number of particles or the evaluation metric value of the etching profile) of the response variable includes heteroscedastic observation noise. The operator creates a dataset (second learning data LD2) in which each value of the parameter is associated with corresponding variance of the number of particles or variance of the evaluation metric value of the etching profile.

The processing part 106 includes a processor. The processing part 106 may include, for example, a central processing unit (CPU), a graphics processing unit (GPU), a neural network processing unit (NPU), or a quantum computer. Alternatively, the processing part 106 may include a general-purpose arithmetic device or a dedicated arithmetic device. For example, the processing part 106 may include a field-programmable gate array (FPGA) or an application specific integrated circuit (ASIC).

Based on instructions from the operator inputted via the operation part 102, the processing part 106 performs various processes such as numerical calculations, information processing, and device control by executing computer programs stored in the storage part 105. For example, the processing part 106 reads the support program SP from the recording medium 200 via the interface part 104 and stores the support program SP in the storage part 105. Further, the processing part 106 executes the support program SP.

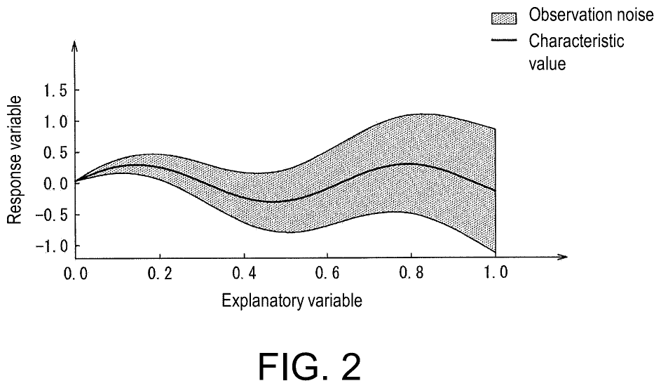

Next, referring to FIG. 2, heteroscedastic observation noise will be described. FIG. 2 is a view showing an example of heteroscedastic observation noise. In FIG. 2, the horizontal axis represents the explanatory variable. The vertical axis represents the response variable. As shown in FIG. 2, in the case where the observation noise is heteroscedastic observation noise, the magnitude of the observation noise differs between a value x1 and another value x2 of the explanatory variable. In heteroscedasticity Bayesian optimization, the value x of the explanatory variable that maximizes or minimizes the response variable (characteristic value) is explored while avoiding the region where the observation noise is large.

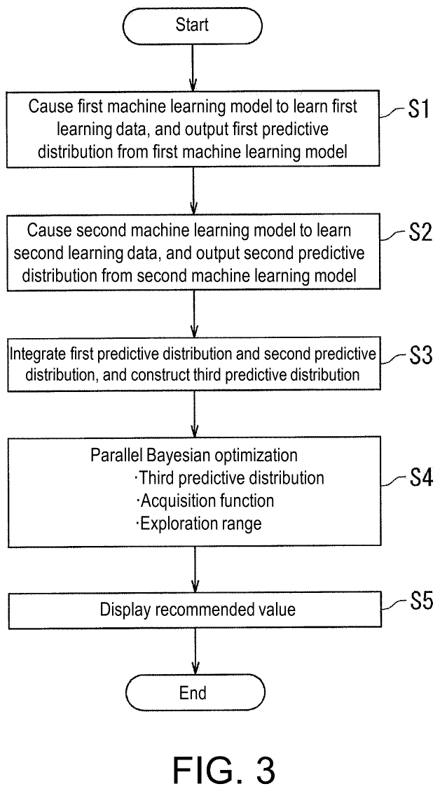

Next, referring to FIG. 1 to FIG. 3, the support method, the recording medium 200, the support program SP, and the support system 100A of this embodiment will be described. FIG. 3 is a flowchart showing a support method of this embodiment. Herein, the support method is a method for supporting exploration of a value x (recommended value or candidate value) of the explanatory variable that optimizes (maximizes or minimizes) the expected value of the response variable. As shown in FIG. 3, the support method of this embodiment includes Step S1 to Step S5.

The support method of this embodiment is executed, for example, by the terminal device 101A included in the support system 100A described with reference to FIG. 1. More specifically, the support method shown in FIG. 3 is executed by the terminal device 101A executing the support program SP read from the recording medium 200. In that case, the flowchart shown in FIG. 3 corresponds to a flow of a process executed by the processing part 106 included in the terminal device 101A. In other words, FIG. 3 shows a process executed by the processing part 106 included in the support system 100A of this embodiment.

With the operator operating the operation part 102 to instruct execution of the support program SP, the process (support method) shown in FIG. 3 starts. Upon starting the process shown in FIG. 3, the processing part 106 causes the first machine learning model ML1 to learn (machine learn) the first learning data LD1, and outputs the first predictive distribution f|D from the first machine learning model ML1 (Step S1). The first predictive distribution f|D indicates the predictive distribution (conditional probability distribution) of the expected value of the response variable.

Specifically, the operator operates the operation part 102 to specify (set) the first learning data LD1 as the dataset to be learned by the first machine learning model ML1. Then, the operator operates the operation part 102 to instruct learning of the first learning data LD1. In response to the instruction from the operator, the processing part 106 executes the preprocessing program FP. As a result, preprocessing is executed on the first learning data LD1. More specifically, each value x of the explanatory variable included in the first learning data LD1 is normalized to be within a range of 0 or more and 1 or less. Further, the response variable is standardized. The processing part 106 causes the first machine learning model ML1 to learn (machine learn) the preprocessed first learning data LD1. As a result, the first predictive distribution f|D is outputted from the first machine learning model ML1 and stored in the storage part 105.

Further, the processing part 106 causes the second machine learning model ML2 to learn (machine learn) the second learning data LD2, and outputs the second predictive distribution g|D from the second machine learning model ML2 (Step S2). The second predictive distribution g|D indicates the predictive distribution (conditional probability distribution) of the variance of the response variable. In other words, the second predictive distribution g|D indicates the predictive distribution of observation noise.

Specifically, the operator operates the operation part 102 to specify (set) the second learning data LD2 as the dataset to be learned by the second machine learning model ML2. Then, the operator operates the operation part 102 to instruct learning of the second learning data LD2. In response to the instruction from the operator, the processing part 106 executes the preprocessing program FP. As a result, preprocessing is executed on the second learning data LD2. More specifically, each value x of the explanatory variable included in the second learning data LD2 is normalized to be within a range of 0 or more and 1 or less. Further, the response variable is standardized. The processing part 106 causes the second machine learning model ML2 to learn (machine learn) the preprocessed second learning data LD2. As a result, the second predictive distribution g|D is outputted from the second machine learning model ML2 and stored in the storage part 105.

An execution order of a first learning process (Step S1) causing the first machine learning model ML1 to learn the first learning data LD1 and a second learning process (Step S2) causing the second machine learning model ML2 to learn the second learning data LD2 may be interchanged. Alternatively, the first learning process (Step S1) and the second learning process (Step S2) may be executed in parallel. In that case, the operator operates the operation part 102 to instruct learning of the first learning data LD1 and the second learning data LD2.

After obtaining the first predictive distribution f|D and the second predictive distribution g|D, the processing part 106 integrates the first predictive distribution f|D and the second predictive distribution g|D, and constructs the third predictive distribution MV|D (Step S3). Specifically, in the case where the first predictive distribution f|D is expressed by the following Formula (4) and the second predictive distribution g|D is expressed by the following Formula (5), the third predictive distribution MV|D is expressed by the following single Formula (6). It should be noted that Formula (4) and Formula (5) express the predictive distributions (conditional probability distributions) outputted from a Gaussian process regression model.

$$f \vert D ∼ N ( {μ}_{f} , {\sum }_{f} ) \qquad ( 4 )$$

$$g \vert D ∼ N ( {μ}_{g} , {\sum }_{g} ) \qquad ( 5 )$$

$$\begin{matrix}MV \vert D = f \vert D - α g \vert D ∼ N ( {μ}_{f} , {\sum }_{f} ) - α N ( {μ}_{g} , {\sum }_{g} ) \\ = N ( {μ}_{f} - α {μ}_{g} , {\sum }_{f} + {α}^{2} {\sum }_{g} )\end{matrix} \qquad ( 6 )$$

Specifically, in heteroscedasticity Bayesian optimization, which is Bayesian optimization that takes into account heteroscedastic observation noise, the value x of the explanatory variable that maximizes or minimizes the objective function MV(x) expressed by the following Formula (7) is explored.

$$MV ( x ) = f ( x ) - α g ( x ) \qquad ( 7 )$$

In Formula (7), f(x) indicates the response variable. g(x) indicates the heteroscedastic observation noise. Further, the coefficient α indicates the risk aversion coefficient. In the case where f(x) is represented using a Gaussian process regression model, f(x) is expressed by the following Formula (8). In the case where g(x) is represented using a Gaussian process regression model, g(x) is expressed by the following Formula (9). In Formula (8) and Formula (9), “mf” and “mg” indicate mean functions. “kf” and “kg” indicate kernel functions.

$$f ∼ ς {P}_{f} ( {m}_{f} , {k}_{f} ) \qquad ( 8 )$$

$$g ∼ ς {P}_{g} ( {m}_{g} , {k}_{g} ) \qquad ( 9 )$$

The first predictive distribution f|D expressed by the above Formula (4) indicates the predictive distribution outputted from the Gaussian process regression model f expressed by Formula (8). The second predictive distribution g|D expressed by the above Formula (5) indicates the predictive distribution outputted from the Gaussian process regression model g expressed by Formula (9). The third predictive distribution MV|D expressed by the above Formula (6) is constructed by integrating Formula (4) and Formula (5) based on the objective function MV(x), using linear transformation of multivariate normal distribution and the property of sum of multivariate normal distributions when independence holds.

After constructing the third predictive distribution MV|D, the processing part 106 executes a recommended value acquisition process (Step S4), and acquires at least one recommended value (or candidate value) of the explanatory variable. Specifically, the processing part 106 executes parallel Bayesian optimization based on the third predictive distribution MV|D, at least one acquisition function AF, and the exploration range to acquire at least one value x (recommended value or candidate value) of the explanatory variable that maximizes the acquisition function AF from within the exploration range.

Before executing parallel Bayesian optimization, the operator operates the operation part 102 to set (input) the type of the acquisition function AF to be used in parallel Bayesian optimization in the source code of the support program SP. Specifically, the operator selects at least one of the acquisition functions AF included in the support program SP, and sets the selected acquisition function AF in the source code of the support program SP. Further, the operator operates the operation part 102 to set (input) the value of the exploration range and the number of values x of the explanatory variable to be presented from one acquisition function AF in the source code of the support program SP. The number of values x of the explanatory variable to be presented from one acquisition function AF indicates an integer of 1 or more. The number of values x of the explanatory variable to be presented from one acquisition function AF may be preset as a fixed value in the support program SP.

In the case where 1 is set as the number of values x of the explanatory variable to be presented from the acquisition function AF, the processing part 106 acquires one recommended value from one acquisition function AF. In the case where an integer of 2 or more is set as the number of values x of the explanatory variable to be presented from the acquisition function AF, the processing part 106 acquires two or more recommended values (multiple recommended values) from one acquisition function AF. For example, in the case where the number of values x of the explanatory variable to be presented from one acquisition function AF is set to 3, parallel Bayesian optimization is performed using two acquisition functions AF to acquire six recommended values (or candidate values).

Finally, the processing part 106 causes the display part 103 to display the recommended value (or candidate value) of the explanatory variable acquired by executing parallel Bayesian optimization (Step S5), and ends the process (support method) shown in FIG. 3.

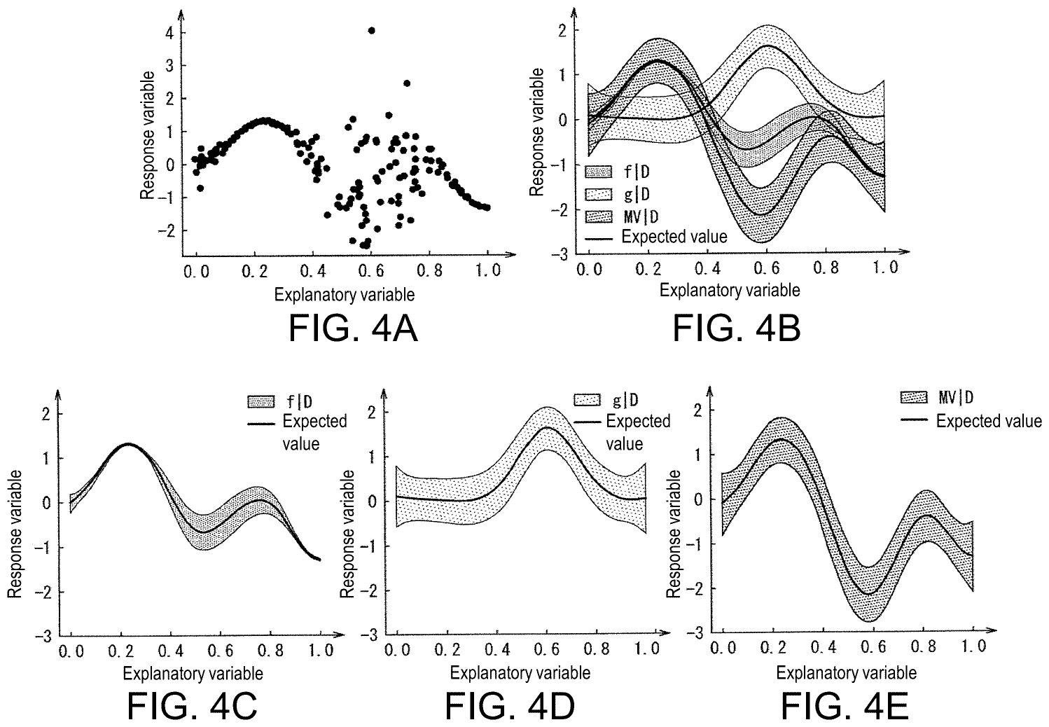

Next, referring to FIG. 4A to FIG. 4E, the first predictive distribution f|D, the second predictive distribution g|D, and the third predictive distribution MV|D will be described. FIG. 4A is a view showing an example of the observed value of the response variable. The data of the observed value shown in FIG. 4A is one-dimensional data. FIG. 4B is a view showing an example of the first predictive distribution f|D, the second predictive distribution g|D, and the third predictive distribution MV|D. FIG. 4C is a view showing the first predictive distribution f|D of FIG. 4B. FIG. 4D is a view showing the second predictive distribution g|D of FIG. 4B. FIG. 4E is a view showing the third predictive distribution MV|D of FIG. 4B. In FIG. 4A to FIG. 4E, the horizontal axis represents the explanatory variable, and the vertical axis represents the response variable.

The first predictive distribution f|D, the second predictive distribution g|D, and the third predictive distribution MV|D in FIG. 4B to FIG. 4E show the predictive distributions with respect to the observed value (one-dimensional data) in FIG. 4A. More specifically, FIG. 4B to FIG. 4E show the expected value and the range of standard deviation for each of the first predictive distribution f|D, the second predictive distribution g|D, and the third predictive distribution MV|D.

As described above with reference to FIG. 1 to FIG. 3 and FIG. 4A to FIG. 4E, according to this embodiment, Bayesian optimization can be executed based on one predictive distribution (third predictive distribution MV|D). Therefore, unlike heteroscedasticity Bayesian optimization, it is possible to use an acquisition function used in general Bayesian optimization. Consequently, parallel Bayesian optimization can be executed. Additionally, the third predictive distribution MV|D is a predictive distribution that integrates the first predictive distribution f|D and the second predictive distribution g|D based on the objective function MV(x) formulated for heteroscedasticity Bayesian optimization. Therefore, by using the third predictive distribution MV|D, it is possible to execute Bayesian optimization that takes into account heteroscedastic observation noise. Thus, according to this embodiment, parallel Bayesian optimization that takes into account heteroscedastic observation noise can be executed.

Next, the acquisition function (acquisition function AF) used for the third predictive distribution MV|D will be described. As already explained, an acquisition function used in general Bayesian optimization can be used for the third predictive distribution MV|D. For example, the support program SP may include at least one of the following as the acquisition function AF: PI (Probability of Improvement) acquisition function, EI (Expected Improvement) acquisition function, Log EI acquisition function, LCB (Lower Confidence Bound) acquisition function, UCB (Upper Confidence Bound) acquisition function, Thompson Sampling (TS), Joint Entropy Search (JES), Predictive Entropy Search (PES), Max-value Entropy Search (MES), and Knowledge Gradient.

Furthermore, in this embodiment, the first machine learning model ML1 includes a Gaussian process regression model. The kernel function of the Gaussian process regression model included in the first machine learning model ML1 may be a twice-differentiable kernel function. Similarly, the second machine learning model ML2 includes a Gaussian process regression model. The kernel function of the Gaussian process regression model included in the second machine learning model ML2 may also be a twice-differentiable kernel function. Examples of the twice-differentiable kernel function include Radial Basis Function (RBF) kernel or Matern-5/2 kernel.

According to this embodiment, the kernel functions of the Gaussian process regression models included in the first machine learning model ML1 and the second machine learning model ML2 are twice-differentiable kernel functions, so a Monte Carlo acquisition function can be used as the acquisition function (acquisition function AF) for the third predictive distribution MV|D. Therefore, the support program SP may include a Monte Carlo acquisition function as the acquisition function AF. Alternatively, the support program SP may include a computer program that acquires a Monte Carlo acquisition function from the acquisition function AF. Specifically, the Monte Carlo acquisition function is an acquisition function that can approximate the gradient of the acquisition function by Monte Carlo methods. For example, acquisition functions such as PI acquisition function, EI acquisition function, LCB acquisition function, UCB acquisition function, and entropy search can be considered as Monte Carlo acquisition functions through equation transformation. The processing part 106 may execute the support program SP, and acquire a Monte Carlo acquisition function by approximating the gradient of the acquisition function AF specified by the operator using Monte Carlo methods.

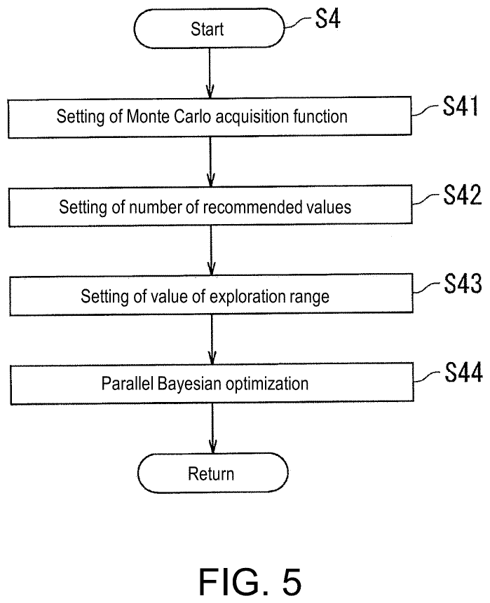

Next, referring to FIG. 5, the recommended value acquisition process (Step S4 in FIG. 3) will be described. FIG. 5 is a view showing an example of the flow of the recommended value acquisition process (Step S4 in FIG. 3). As shown in FIG. 5, the recommended value acquisition process (Step S4 in FIG. 3) may include Step S41 to Step S44. Step S41 indicates a process of receiving setting (input) of multiple Monte Carlo acquisition functions with different properties. Step S42 indicates a process of receiving setting (input) of the number of recommended values (or candidate values) to be presented from one acquisition function AF. Step S43 indicates a process of receiving setting (input) of the value of the exploration range. Step S44 indicates a process of executing parallel Bayesian optimization.

When starting the process shown in FIG. 5, the processing part 106 receives setting (input) of multiple Monte Carlo acquisition functions with different properties from each other (Step S41). Specifically, an input field (line) for receiving setting (input) of multiple Monte Carlo acquisition functions is provided in the source code of the support program SP. The operator operates the operation part 102 to input information indicating multiple Monte Carlo acquisition functions with different properties from each other into the source code of the support program SP. The multiple Monte Carlo acquisition functions with different properties from each other include, for example, acquisition functions such as PI acquisition function, EI acquisition function, LCB acquisition function, UCB acquisition function, and entropy search. The operator may also input information indicating multiple acquisition functions AF with different properties from each other, and the processing part 106 may acquire multiple Monte Carlo acquisition functions corresponding to the set multiple acquisition functions AF through computation.

Next, the processing part 106 receives setting (input) of the number of recommended values (or candidate values) to be presented from one acquisition function AF (Step S42). Specifically, an input field (line) for receiving setting (input) of the number of recommended values (or candidate values) to be presented from one acquisition function AF is provided in the source code of the support program SP. The input field (line) for receiving setting (input) of the number of recommended values (or candidate values) receives an integer value of 1 or more. The operator operates the operation part 102 to input the number of recommended values (or candidate values) to be presented from one acquisition function AF into the source code of the support program SP.

Next, the processing part 106 receives setting (input) of the value of the exploration range (Step S43). Specifically, an input field (line) for receiving setting (input) of the value of the exploration range is provided in the source code of the support program SP. The operator operates the operation part 102 to input the value of the exploration range into the source code of the support program SP.

Next, the processing part 106 executes parallel Bayesian optimization (Step S44). As a result, the process (Step S4) shown in FIG. 5 is completed.

In addition, the processing part 106 may receive setting (input) of the number of recommended values (or candidate values) for each of multiple acquisition functions AF used in parallel Bayesian optimization. Specifically, an input field (line) for receiving setting of the number of recommended values (or candidate values) for each acquisition function AF used in parallel Bayesian optimization may be provided in the source code of the support program SP.

Although in the example shown in FIG. 5, each process of Step S41 to Step S43 is executed after constructing the third predictive distribution MV|D (after executing Step S3 in FIG. 3), some or all of the processes of Step S41 to Step S43 may be executed before constructing the third predictive distribution MV|D (before executing Step S3 in FIG. 3). Specifically, each process of Step S41 to Step S43 may be executed as long as it is executed before parallel Bayesian optimization (Step S44) is executed. For example, the processes of Step S41 to Step S43 may be executed before execution of Step S1 in FIG. 3.

Although in the example shown in FIG. 5, each process of Step S41 to Step S43 is executed in the order of Step S41, Step S42, and Step S43, the execution order of Step S41, Step S42, and Step S43 can be interchanged.

In this embodiment, the processing part 106 executes parallel Bayesian optimization based on Thompson sampling and parallel Bayesian optimization based on each of multiple Monte Carlo acquisition functions set by the operator in Step S4 (recommended value acquisition process) of FIG. 3.

According to this embodiment, multiple recommended values (or candidate values) can be acquired from Thompson sampling, and multiple recommended values (or candidate values) can be acquired from each of multiple Monte Carlo acquisition functions with different properties from each other. Therefore, the operator can more efficiently determine the value x of the explanatory variable that optimizes (maximizes or minimizes) the response variable.

In addition, an upper limit may be set for the number of recommended values (or candidate values) to be presented from one acquisition function AF. Specifically, an upper limit may be preset for the value in the input field for setting the number of recommended values (or candidate values). The upper limit may be, for example, 5. By setting an upper limit for the number of recommended values (or candidate values), it is less likely for bias to occur in the multiple recommended values (or candidate values) to be presented from multiple acquisition functions AF. Therefore, the operator can more efficiently determine the value x of the explanatory variable that optimizes (maximizes or minimizes) the response variable.

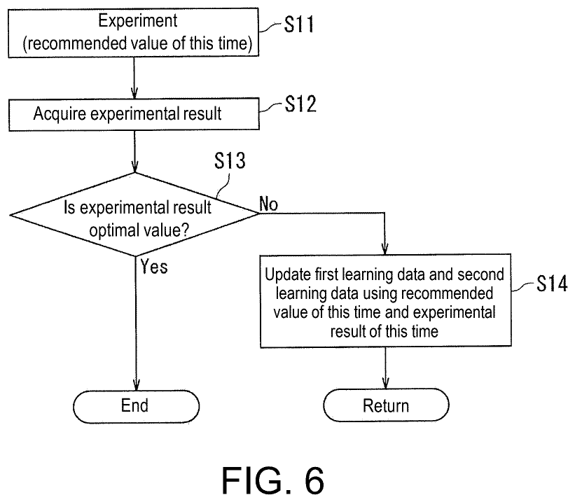

Next, referring to FIG. 6, a procedure of an experiment using the support method, the recording medium 200, the support program SP, and the support system 100A of this embodiment will be described. FIG. 6 is a view showing the procedure of the experiment using the support method, the recording medium 200, the support program SP, and the support system 100A of this embodiment.

The experiment procedure shown in FIG. 6 is started after the support method shown in FIG. 3 is executed. As shown in FIG. 6, the operator performs multiple experiments using multiple recommended values (recommended values of this time) acquired by executing the support method shown in FIG. 3 (Step S11), and acquires multiple experimental results (multiple values of the response variable) (Step S12). In other words, the operator performs multiple experiments to acquire multiple observation values. Then, the operator determines whether any of the experimental results (values of the response variable) is an optimal value (maximum value or minimum value) (Step S13).

In the case where the operator determines that none of the experimental results is the optimal value (“No” in Step S13), the operator updates the first learning data LD1 and the second learning data LD2 using multiple values x (recommended values of this time) of the explanatory variable used in the experiment of this time and multiple experimental results (multiple values of the response variable) of this time (Step S14), and executes the support method described with reference to FIG. 3 again. Then, until the operator determines that an experimental result is the optimal value, the operator repeats update of the first learning data LD1 and the second learning data LD2 (Step S14), the support method described with reference to FIG. 3, and the experiment (Step S11 and Step S12).

Upon determining that any of the experimental results is the optimal value (“Yes” in Step S13), the operator ends the experiment. For example, the operator may end the experiment in the case of determining that any of the experimental results has converged to a value within a target range.

Embodiment 1 of the disclosure has been described above with reference to FIG. 1 to FIG. 6. According to Embodiment 1, it is possible to execute Bayesian optimization that takes into account heteroscedastic observation noise. Furthermore, according to Embodiment 1, it is possible to execute parallel Bayesian optimization, and acquire multiple recommended values (or candidate values) of the explanatory variable by a single process. Therefore, compared to the case of acquiring one recommended value (or candidate value) per process, the operator can more efficiently determine the value x of the explanatory variable that optimizes (minimizes or maximizes) the value of the response variable.

In the embodiment described with reference to FIG. 1 to FIG. 6, the support system 100A (terminal device 101A) acquires the support program SP from the recording medium 200, but the support system 100A (terminal device 101A) may also acquire the support program SP from another computer system. For example, the terminal device 101A may be communicably connected to another computer system via a cable and acquire the support program SP from the another computer system. Alternatively, the terminal device 101A may be communicably connected to another computer system via a network such as the Internet and acquire the support program SP from the another computer system. The another computer system may be a general-purpose computer or a dedicated computer. The another computer system may also be a server.

Further, in the embodiment described with reference to FIG. 1 to FIG. 6, the support program SP is installed on the terminal device 101A, but it is also possible that the support program SP is not installed on the terminal device 101A. The terminal device 101A may execute the support program SP stored in the recording medium 200.

### Embodiment 2

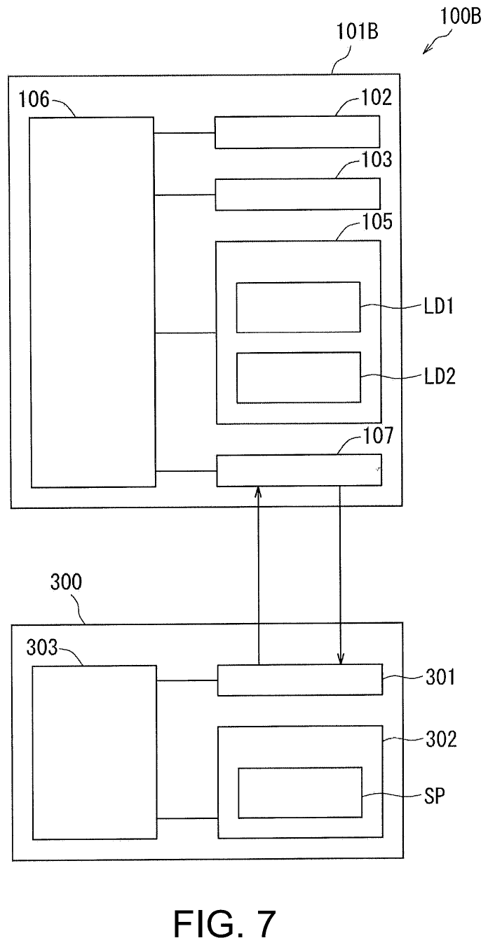

Next, Embodiment 2 of the disclosure will be described with reference to FIG. 3 and FIG. 7. However, only aspects that differ from Embodiment 1 will be described, and descriptions of aspects that are the same as in Embodiment 1 will be omitted. Embodiment 2 differs from Embodiment 1 in that a server 300 outputs at least one recommended value (candidate value) of the explanatory variable based on the support program SP.

FIG. 7 is a block diagram showing a configuration of a support system 100B of Embodiment 2. As shown in FIG. 7, the support system 100B includes a terminal device 101B and a server 300.

In Embodiment 2, the terminal device 101B includes an operation part 102, a display part 103, a storage part 105, a communication part 107, and a processing part 106.

The communication part 107 is connected to a network and executes communication with the server 300. The network includes, for example, the Internet, a local area network (LAN), a public telephone network, and a short-range wireless network. The communication part 107 includes a communication device. The communication part 107 is, for example, a network interface controller.

The communication part 107 is controlled by the processing part 106 to exchange information, data, or signals with the server 300. For example, the communication part 107 transmits to the server 300 the first learning data LD1, the second learning data LD2, information for setting the type of acquisition function AF used in parallel Bayesian optimization, information for setting the number of values x (recommended values or candidate values) of the explanatory variable to be presented from one acquisition function AF, and information for setting the value of the exploration range.

The server 300 includes a communication part 301, a storage part 302, and a processing part 303.

The communication part 301 is connected to a network and executes communication with the terminal device 101B. The communication part 301 includes a communication device. The communication part 301 is, for example, a network interface controller. The communication part 301 is controlled by the processing part 303 to exchange information, data, or signals with the terminal device 101B. For example, the communication part 301 receives from the terminal device 101B the first learning data LD1, the second learning data LD2, information for setting the type of acquisition function AF used in parallel Bayesian optimization, information for setting the number of values x (recommended values or candidate values) of the explanatory variable to be presented from one acquisition function AF, and information for setting the value of the exploration range.

The storage part 302 has a main storage device and an auxiliary storage device. The main storage device includes, for example, a semiconductor memory. The auxiliary storage device includes, for example, a hard disk drive. The storage part 302 stores the support program SP. Further, the storage part 302 stores the first learning data LD1, the second learning data LD2, information for setting the type of acquisition function AF used in parallel Bayesian optimization, information for setting the number of values x (recommended values or candidate values) of the explanatory variable to be presented from one acquisition function AF, and information for setting the value of the exploration range, which are received from the terminal device 101B.

The processing part 303 includes a processor. The processing part 303 may include, for example, a CPU, a GPU, an NPU, or a quantum computer. Alternatively, the processing part 303 may include a general-purpose arithmetic device or a dedicated arithmetic device. For example, the processing part 303 may include an FPGA or an ASIC. The processing part 303 executes the support program SP based on an instruction from the terminal device 101B.

Next, referring to FIG. 7 and FIG. 3, the support method, the support program SP, and the support system 100B of Embodiment 2 will be described. The processing part 303 starts the process shown in FIG. 3 based on an instruction from the terminal device 101B.

Upon starting the process shown in FIG. 3, the processing part 303 causes the first machine learning model ML1 to learn (machine learn) the first learning data LD1 received from the terminal device 101B, and outputs a predictive distribution (first predictive distribution f|D) of the expected value of the response variable from the first machine learning model ML1 (Step S1). Further, the processing part 303 causes the second machine learning model ML2 to learn (machine learn) the second learning data LD2 received from the terminal device 101B, and outputs a predictive distribution (second predictive distribution g|D) of the variance of the response variable from the second machine learning model ML2 (Step S2).

After acquiring the first predictive distribution f|D and the second predictive distribution g|D, the processing part 303 integrates the first predictive distribution f|D and the second predictive distribution g|D to construct the third predictive distribution MV|D (Step S3).

After constructing the third predictive distribution MV|D, the processing part 303 executes parallel Bayesian optimization based on the third predictive distribution MV|D, at least one acquisition function AF, and the exploration range to obtain at least one value x (recommended value or candidate value) of the explanatory variable that maximizes the acquisition function AF from within the exploration range (Step S4). Then, the processing part 303 sends information indicating at least one recommended value (or candidate value) to the terminal device 101B to display the recommended value (or candidate value) of the explanatory variable on the display part 103 (Step S5). As a result, the process (support method) shown in FIG. 3 is completed.

Specifically, the processing part 303 sends screen information showing the source code of the support program SP to the terminal device 101B, and causes the display part 103 of the terminal device 101B to display a screen showing the source code of the support program SP. As described with reference to FIG. 5, the operator operates the operation part 102 to input information indicating at least one acquisition function AF used in parallel Bayesian optimization, information indicating the number of recommended values (or candidate values) to be presented from one acquisition function AF, and information indicating the value of the exploration range to the screen showing the source code of the support program SP. As a result, the information inputted to the screen showing the source code of the support program SP by the operator's operation of the operation part 102 is sent from the terminal device 101B to the server 300. The processing part 303 executes parallel Bayesian optimization based on the information obtained from the terminal device 101B and the third predictive distribution MV|D.

Embodiment 2 of the disclosure has been described above with reference to FIG. 3 and FIG. 7. According to Embodiment 2, parallel Bayesian optimization that takes into account distributed observation noise can be performed, similar to Embodiment 1.

### Embodiment 3

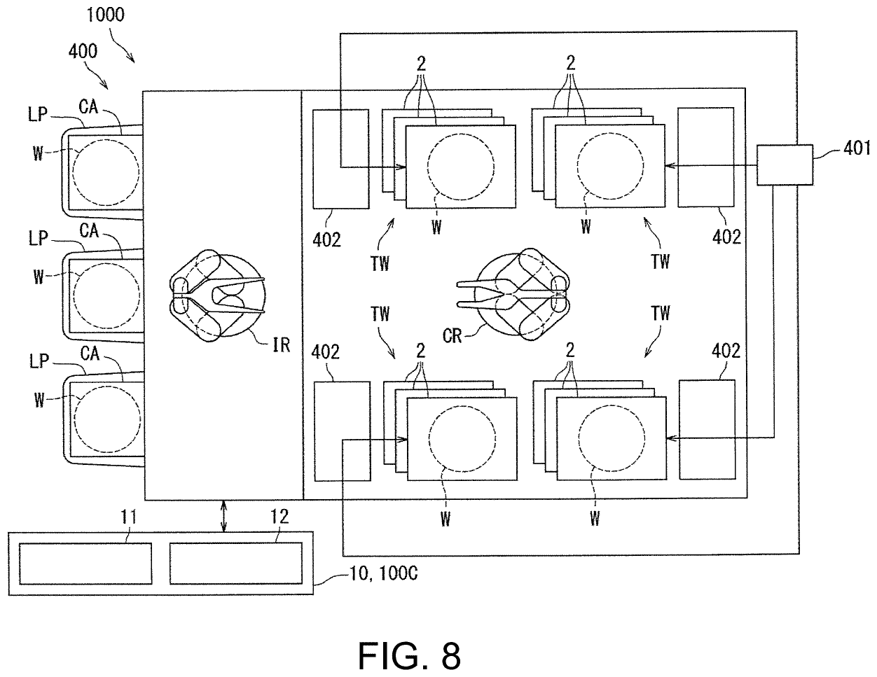

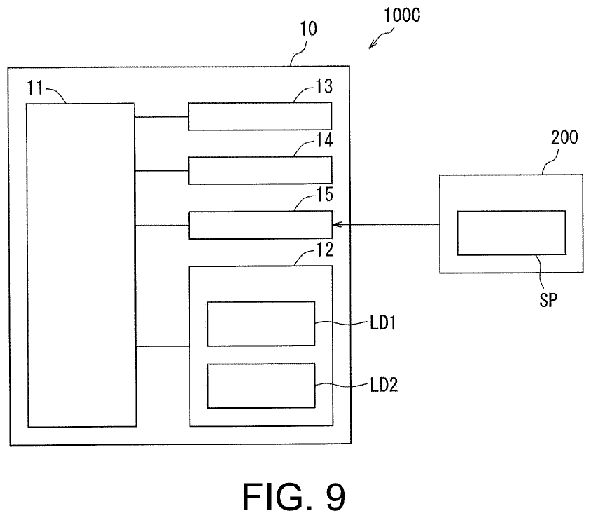

Next, Embodiment 3 of the disclosure will be described with reference to FIG. 8 and FIG. 9. However, only aspects that differ from Embodiments 1 and 2 will be described, and descriptions of aspects that are the same as in Embodiments 1 and 2 will be omitted.

Embodiment 3 differs from Embodiments 1 and 2 in that a control device 10 included in a substrate processing system 1000 also serves as a support system 100C.

FIG. 8 is a schematic view of the substrate processing system 1000 including the support system 100C of this embodiment. Specifically, FIG. 8 is a schematic plan view of a substrate processing apparatus 400 included in the substrate processing system 1000.

As shown in FIG. 8, the substrate processing system 1000 includes a substrate processing apparatus 400 and a control device 10. The substrate processing apparatus 400 processes a substrate W. The control device 10 controls the substrate processing apparatus 400. In this embodiment, the substrate W is a disk-shaped semiconductor wafer. Further, the substrate processing apparatus 400 is a single-type apparatus that processes one substrate W at a time.

Specifically, the substrate processing apparatus 400 includes multiple substrate processing parts 2, a fluid cabinet 401, multiple fluid boxes 402, multiple load ports LP, an indexer robot IR, and a center robot CR.

A cassette CA is placed at each of the load ports LP. The cassette CA accommodates multiple substrates W stacked. The cassette CA is, for example, a front opening unified pod (FOUP), a standard mechanical interface (SMIF) pod, or an open cassette (OC).

The indexer robot IR transports the substrate W between the cassette CA and the center robot CR. The center robot CR transports the substrate W between the indexer robot IR and the multiple substrate processing parts 2. The apparatus may also be configured such that a placement stage (pass) for temporarily placing the substrate W is provided between the indexer robot IR and the center robot CR to indirectly transfer the substrate W between the indexer robot IR and the center robot CR via the placement stage.

The multiple substrate processing parts 2 form multiple towers TW (four towers TW in FIG. 8). The multiple towers TW are disposed to surround the center robot CR in a plan view. Each tower TW includes multiple substrate processing parts 2 (three substrate processing parts 2 in FIG. 8) stacked in an up-down direction.

The fluid cabinet 401 accommodates a fluid. Specifically, the fluid cabinet 401 accommodates a processing solution. Alternatively, the fluid cabinet 401 may accommodate a processing solution and a gas.

The processing solution is not particularly limited as long as it is a liquid that contacts the substrate W. The processing solution may include, for example, dilute hydrofluoric acid (DHF), hydrofluoric acid (HF), nitrohydrofluoric acid (a mixed solution of hydrofluoric acid and nitric acid (HNO₃)), buffered hydrofluoric acid (BHF), ammonium fluoride, HFEG (a mixed solution of hydrofluoric acid and ethylene glycol), phosphoric acid (H₃PO₄), sulfuric acid, acetic acid, nitric acid, hydrochloric acid, ammonia water, hydrogen peroxide water, organic acid (e.g., citric acid, oxalic acid), organic alkali (e.g., tetramethylammonium hydroxide (TMAH)), sulfuric acid-hydrogen peroxide mixture (SPM), ammonia-hydrogen peroxide mixture (SC1), hydrochloric acid-hydrogen peroxide mixture (SC2), isopropyl alcohol (IPA), a surfactant, a corrosion inhibitor, pure water (e.g., deionized water), carbonated water, electrolyzed ionic water, hydrogen water, ozone water, or hydrochloric acid water with a diluted concentration (e.g., about 0.001 wt % to about 0.01 wt %). The gas may include, for example, an inert gas. The inert gas is, for example, nitrogen gas.

Each fluid box 402 corresponds to one of the multiple towers TW. The fluid in the fluid cabinet 401 is supplied to all substrate processing parts 2 included in the corresponding tower TW via one of the fluid boxes 402.

Each of the substrate processing parts 2 processes one substrate W at a time. Specifically, each of the substrate processing parts 2 supplies the processing solution to the substrate W to process the substrate W. For example, each of the substrate processing parts 2 performs a cleaning process or an etching process on the substrate W.

The control device 10 controls an action of each part of the substrate processing apparatus 400. For example, the control device 10 controls the substrate processing part 2, the fluid cabinet 401, the fluid box 402, the load port LP, the indexer robot IR, and the center robot CR. The control device 10 includes a control part 11 and a storage part 12.

The control part 11 controls the action of each part of the substrate processing apparatus 400 based on various information stored in the storage part 12. The control part 11 includes a processor. The control part 11 may include, for example, a CPU, a GPU, an NPU, or a quantum computer. Alternatively, the control part 11 may include a general-purpose arithmetic device or a dedicated arithmetic device. For example, the control part 11 may include an FPGA or an ASIC.

The storage part 12 stores various information for controlling the action of the substrate processing apparatus 400. For example, the storage part 12 stores various data and various computer programs. The various data includes recipe data. The recipe data indicates recipes that specify processing contents, processing conditions, and processing procedures of the substrate W. In the recipes, various setting values (recipe parameter values) are set as processing conditions.

The storage part 12 has a main storage device. The main storage device includes, for example, a semiconductor memory. The storage part 12 may further have an auxiliary storage device. The auxiliary storage device includes, for example, at least one of a semiconductor memory and a hard disk drive.

FIG. 9 is a block diagram showing a configuration of the support system 100C of this embodiment. Specifically, FIG. 9 is a block diagram showing the configuration of the control device 10.

As shown in FIG. 8 and FIG. 9, the control device 10 also serves as the support system 100C. Specifically, as shown in FIG. 9, the support program SP is installed in the control device 10 from the recording medium 200. Similar to the terminal device 101A described with reference to FIG. 1 to FIG. 6, the control device 10 executes the support program SP installed from the recording medium 200 to explore a value (recommended value or candidate value) of the explanatory variable that optimizes the expected value of the response variable. The control device 10 is an example of a “support device”.

Specifically, as shown in FIG. 9, the control device 10 further includes an operation part 13, a display part 14, and an interface part 15. Configurations of the operation part 13, the display part 14, and the interface part 15 are similar to those of the operation part 102, the display part 103, and the interface part 104 described with reference to FIG. 1, so descriptions thereof will be omitted.

Similar to the storage part 105 described with reference to FIG. 1, the storage part 12 stores the first learning data LD1, the second learning data LD2, and the support program SP read from the recording medium 200 by the interface part 15. In the substrate processing system 1000, the explanatory variable may include, for example, at least one of various setting values (recipe parameter values) specified by the recipes and various setting values (apparatus parameter values) set for the substrate processing apparatus 400. Further, in the case where the substrate processing part 2 executes a cleaning process, the response variable may be, for example, a number of particles. In the case where the substrate processing part 2 executes an etching process, the response variable may be, for example, an evaluation metric value of the etching profile.

Similar to the processing part 106 described with reference to FIG. 1 to FIG. 6, the control part 11 executes the support program SP to output at least one value x (recommended value or candidate value) of the explanatory variable that optimizes the expected value of the response variable.

Embodiment 3 of the disclosure has been described above with reference to FIG. 8 and FIG. 9. According to Embodiment 3, parallel Bayesian optimization that takes into account distributed observation noise can be performed, similar to Embodiments 1 and 2.

In Embodiment 3, the substrate processing apparatus 400 performs a cleaning process or an etching process on the substrate W, but the substrate processing apparatus 400 is not particularly limited as long as it is an apparatus that processes a substrate. For example, the substrate processing apparatus 400 may also be a coating apparatus, a developing apparatus, an exposure apparatus, a baking apparatus, or a film formation apparatus.

Further, in Embodiment 3, the substrate processing apparatus 400 is a single-type apparatus, but the substrate processing apparatus 400 may also be a batch-type apparatus.

Further, in Embodiment 3, the substrate processing apparatus 400 processes a disk-shaped semiconductor wafer, but the targeted substrate of substrate processing is not limited to a semiconductor wafer. The targeted substrate of substrate processing may also be a glass substrate for a photomask, a glass substrate for liquid crystal display, a glass substrate for plasma display, a substrate for field emission display (FED), a substrate for an optical disk, a substrate for a magnetic disk, or a substrate for a magneto-optical disk. Further, a shape of the targeted substrate of substrate processing is not limited to a disk-shape.

The embodiments of the disclosure have been described above with reference to the drawings (FIG. 1 to FIG. 9). However, the disclosure is not limited to the above-described embodiments and may be implemented in various aspects within a range without deviating from the gist thereof. Further, multiple constituent elements disclosed in the above embodiments may be appropriately modified. For example, one constituent element among all constituent elements shown in one embodiment may be added to constituent elements of another embodiment, or some constituent elements among all constituent elements shown in one embodiment may be deleted from the embodiment.

To facilitate understanding of the disclosure, the drawings schematically show each constituent element as a main body. A thickness, a length, a number, an interval, etc. of each constituent element shown may differ from reality for convenience of drawing creation. Further, a configuration of each constituent element shown in the above embodiments is an example, is not particularly limited, and may be subjected to various changes within a range without substantially deviating from the effect of the disclosure.

For example, in the embodiments described with reference to FIG. 1 to FIG. 9, the support program SP includes the preprocessing program FP, but it is also possible that the support program SP does not include the preprocessing program FP. For example, a program for preprocessing created by the operator may be stored in the storage part 105.

In addition, in the embodiments described with reference to FIG. 1 to FIG. 9, parallel Bayesian optimization based on Thompson sampling and parallel Bayesian optimization based on each of multiple Monte Carlo acquisition functions are executed, but parallel Bayesian optimization based on one type of acquisition function AF may be executed.

Moreover, in the embodiments described with reference to FIG. 1 to FIG. 9, multiple recommended values (or candidate values) are obtained for each process, but one recommended value (or candidate value) may be obtained for each process.

Furthermore, in the embodiments described with reference to FIG. 1 to FIG. 9, the operator set multiple Monte Carlo acquisition functions with different properties from each other, but the multiple Monte Carlo acquisition functions used in parallel Bayesian optimization may be preset as fixed values in the support program SP.

The disclosure is useful for methods and systems that execute Bayesian optimization for a predictive distribution that includes heteroscedastic observation noise.

What is claimed is:

1. A support method, supporting exploration of a value of an explanatory variable that maximizes or minimizes an expected value of a response variable, the support method comprising:
outputting, from a first machine learning model capable of outputting a predictive distribution, a first predictive distribution which is a predictive distribution of the expected value of the response variable;
outputting, from a second machine learning model capable of outputting a predictive distribution, a second predictive distribution which is a predictive distribution of a variance of the response variable;
constructing a third predictive distribution that integrates the first predictive distribution and the second predictive distribution; and
a recommended value acquisition process of executing parallel Bayesian optimization based on the third predictive distribution, at least one acquisition function, and an exploration range, and acquiring at least one recommended value of the explanatory variable that maximizes the acquisition function from within the exploration range.

2. The support method according to claim 1, further comprising acquiring a plurality of the recommended values in the recommended value acquisition process.

3. The support method according to claim 1, wherein the first machine learning model and the second machine learning model each comprise a twice-differentiable kernel function, and
the at least one acquisition function comprises a Monte Carlo acquisition function.

4. The support method according to claim 3, wherein the at least one acquisition function comprises Thompson sampling and a plurality of Monte Carlo acquisition functions with different properties from each other, and
the support method further comprises acquiring a plurality of the recommended values from the Thompson sampling, and acquiring a plurality of the recommended values from each of the plurality of Monte Carlo acquisition functions in the recommended value acquisition process.

5. A recording medium, which is a computer-readable recording medium, recording a support program specifying the support method according to claim 1.

6. A support system, supporting exploration of a value of an explanatory variable that maximizes or minimizes an expected value of a response variable, the support system comprising:
a storage part storing a first machine learning model capable of outputting a predictive distribution, a second machine learning model capable of outputting a predictive distribution, and at least one acquisition function; and
a processing part outputting a first predictive distribution, which is a predictive distribution of the expected value of the response variable, from the first machine learning model, and outputting a second predictive distribution, which is a predictive distribution of a variance of the response variable, from the second machine learning model, wherein
the processing part is configured to:
construct a third predictive distribution that integrates the first predictive distribution and the second predictive distribution, and
execute parallel Bayesian optimization based on the third predictive distribution, the acquisition function, and an exploration range, and acquire at least one recommended value of the explanatory variable that maximizes the acquisition function from within the exploration range.

7. The support system according to claim 6, wherein the processing part is configured to acquire a plurality of the recommended values.

8. The support system according to claim 6, wherein the first machine learning model and the second machine learning model each comprise a twice-differentiable kernel function, and
the at least one acquisition function comprises a Monte Carlo acquisition function.

9. The support system according to claim 8, wherein the at least one acquisition function comprises Thompson sampling and a plurality of Monte Carlo acquisition functions with different properties from each other, and
the processing part is configured to acquire a plurality of the recommended values from the Thompson sampling, and acquire a plurality of the recommended values from each of the plurality of Monte Carlo acquisition functions.
